(19) United States
(12) Patent Application Publication
(10) Pub. No.: US 2006/0190718 A1
(43) Pub. Date: Aug. 24, 2006

(54) Method and system of providing political campaign material

(76) Inventors: Ravneet Singh, Washington, DC (US); Simerneet Singh, Washington, DC (US)

Correspondence Address: Frank C Nicholas;Cardinal Law Group, 1603 Orrington Avenue, Suite 2000, Evanston, IL, 60201, US

(21) Appl. No.: 10/559,270

(22) PCT Filed: Jun. 4, 2004
(86) PCT No.: PCT/US04/17854

§ 371 Date: Dec. 2, 2005

Related U.S. Application Data
(60) Provisional application No. 60/476,558, filed on Jun. 6, 2003.

(51) Int. Cl. H04L 9/00

(52) U.S. Cl. 713/155

(57) ABSTRACT

A method for certification of a political website in accordance with one embodiment of the invention determines a candidate name and office (210). The method confirms that the determined name is registered to run for the office (220). The method confirms that the URL associated with the website is controlled by the determined name (230).

### CROSS REFERENCE TO RELATED APPLICATIONS

Applicant claims the benefit of U.S. Provisional Patent Application, 60/476,558, filed Jun. 6, 2003, the entirety of which is incorporated by reference herein.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyrights whatsoever.

### FIELD OF THE INVENTION

The present invention relates to an electronic format for certifying a political website.

### BACKGROUND OF THE INVENTION

Currently, political campaigns have utilized traditional media for transmitting the message of a political candidate. Print media, radio, television, telephone and direct mail are methods primarily used to educate the voter on a specific candidate's platform and his/her messages, as well as to create name recognition. As Internet usage increases in this country, more and more people have access to the Internet and the political arena. Furthermore, a good portion of those who have access to the Internet are educated and more likely to vote. Therefore, “e-Campaigning,” campaigning over the Internet, has become more common. During the 2000 primary election campaigns, all Presidential candidates had an Internet site. However, what they did with it and how they utilized it to help them gain voters and name recognition, as well as funding, was very poor.

However, with the advent of large scale political campaigning over the Internet, the potential for large scale political mudslinging has increased. Many people, hoping to capitalize on web user's confusion, name a website with a name that is confusingly similar to a web site that a user desires to locate. For instance, a user attempting to locate information about the White House might attempt to access whitehouse.com rather than whitehouse.gov. The content on whitehouse.com is unlikely to provide the information desired by the person seeking whitehouse.gov. Other politicians or their supporters may also place inaccurate or disparaging information regarding another candidate on a website with a confusing name.

Other concerns of Internet users include security of private information, and privacy of their information. Internet users are concerned about unsolicited political email, and desire a level of trust with political websites that they visit. Internet users desire a level of trust from political websites on par with the trust they demand from the public servants they elect.

More information on political web concerns is found in Privacy, Security and Trust on the Political Web, published by the Institute for Politics Democracy and the Internet, written by Jonah D. Seiger, and published on Mar. 21, 2003, attached herein as FIG. 1.

Therefore, there is a need for consumers to be certain that the information on a website is accurate and is from the desired source. Certification systems have been developed that attempt to certify that the website being accessed is sponsored by the desired entity, but they do not address the particular needs of politicians, and do not comply with election law requirements.

### SUMMARY OF THE INVENTION

One aspect of the invention provides a method for certification of a political website including the step of determining a candidate name and office. The method further confirms that the determined name is registered to run for the office; and confirms that the URL associated with the website is controlled by the determined name.

The aforementioned, and other features and advantages of the invention, will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE FIGURES

FIG. 1 illustrates prior art concerns about information on political websites;

FIG. 2 illustrates one embodiment of a method for certification of political websites, in accordance with one aspect of the invention;

FIG. 3 illustrates one embodiment of a code of conduct in accordance with one aspect of the invention; and

FIG. 4 illustrates one embodiment of a scoring system to allow for different levels of certifications in accordance with one aspect of the invention.

### DETAILED DESCRIPTION OF THE PRESENTLY-PREFERRED EMBODIMENTS

FIG. 1 illustrates a method for certification of a political website in accordance with one embodiment of the invention. The method 200 begins at 210 by determining a candidate name and office. At step 220, method 200 confirms that the determined name is registered to run for the office. At step 230, method 200 confirms that the URL associated with the website is controlled by the determined name.

Determining a candidates name and office, as in 210, may comprise the certification authority obtaining and/or confirming the candidate's name and office sought. The determination may be with a computer, Internet, web or human assisted interface. In one embodiment, the interface is provided to a user, such as campaign personnel, and the user inputs the information into the interface. Software may check databases to determine if the candidate has previously been certified by the authority, or if the campaign has a preexisting account. The software may further check databases for client and office registration. Thus, for example, if George W. Bush is the candidate, the Bush campaign provides information to the interface that George W. Bush is a candidate for the elected office of President.

Confirming that the determined name is registered to run for office, as in step 220, comprises matching the name with candidate lists maintained by election authorities, such as the Federal Election Commission. After obtaining and/or confirming the name of the candidate and the office, the certification authority confirms with the relevant election commission that the candidate is actually seeking office. In one embodiment, the confirmation is conducted by comparing the obtained name and/or office to records maintained by at least one database. Thus, if George W. Bush is running for United States President, the Federal Election Commission will list George W. Bush as a candidate for the office of President, and when the certification authority attempts to confirm that George W. Bush is running for President, the records of the election authority will match the determined name. If the candidate is not officially running for the designated office, then the certification authority will not certify the website, in one embodiment, or the certification authority may require further information prior to certification. Other election authorities may include state, local, county or other lower governmental entities that maintain a database.

Confirming that the URL associated with the website is controlled by the determined name, as in 230, comprises comparing the determined name with records maintained by web registrars. The comparison may be performed electronically, i.e. using the Internet or web, or with human assistance. Thus, if George W. Bush is running for office, the certification authority will not certify a website for George W. Bush for which the URL is registered to another person or candidate. As known to those of skill in the art, Internet registration authorities maintain a list of the ownership of URLs. The URL ownership is compared to the confirmed name and/or the FEC listed name, and if the names are different the certification authority will deny certification or request further information.

In one embodiment, the certification authority will require further steps to issue a certification. For example, the certification authority may require that the website and/or politician adhere or swear to a code of conduct. An exemplary code of conduct is attached as FIG. 3. In one embodiment, the code of conduct can be displayed at the interface and request an input to indicate agreement to adhere to the code.

In other embodiments, the certification authority may require that the website comply with federal laws. For example, the certification authority may require that the website comply with Section 508 of the Rehabilitation Act and the Electronic and Information Technology Accessibility Standards. In another embodiment, the website may be HIPPA compliant. In one embodiment, the certification authority relies on a statement from the candidate, while in other embodiments, the certification authority relies on an inspection, electronic or human, of the website to ensure compliance. For example, in one embodiment, the website can be scanned and compared to a keyword index of compliance terms and phrases.

In other embodiments, a scoring system is used to allow for different levels of certifications. An exemplary scoring system is disclosed in FIG. 4. Depending on the score attained by the website, a different certification may be granted. For example, a gold certification and a silver certification level are offered. The scoring is premised on the features and completeness of the website. Scoring may be adjusted for a confidence level of the candidate's identity—for example, if the URL owner is not identical with the candidate, the authority, in an embodiment, may issue a lower certification.

In other embodiments, the certification authority requires adherence to a spam, or unsolicited commercial email, code. In an exemplary embodiment, the certification authority will require the website to refrain from the use of unsolicited commercial email. In other embodiments, the certification authority may require that the politician refrain from email address “harvesting” when obtaining email addresses. In other embodiments, the certification authority requires the politician to only engage in “opt-in” email. In another exemplary embodiment, the certification authority may require that the website take steps to reduce the incidence of multiple copies of an email being sent to the same address. In another embodiment, the certification authority requires the website to adopt a code, such as the following exemplary code:
“I will not spam or send unsolicited email to voters, visitors, or users of my election website without attempting to seek their permission. I will provide every effort to comply to the federal and state laws regarding spamming. All email lists that I collect will remain confidential and private and be utilized for campaign purposes only.”

In other embodiments, the certification authority may also certify that data collected by the website is secure. In one embodiment, this security is determined by adherence to a data security policy. This level of security may comprise a variety of levels. In certain embodiments of the invention, the certification authority will require that data collected by the website is stored securely. In certain embodiments, the certification authority may require that any collected data is stored behind a firewall or on a server not connected to the Internet. In other embodiments, the certification authority may require that data types are stored in a fashion different from other data types. For example, the certification authority may require that volunteer information is stored separately from contribution data. In other embodiments, the security promised by the website is tested by the certification authority prior to issuance of the certificate. In one embodiment, the certification authority may be run in coordination with an existing certificate provider such as, for example, Comodo or VeriSign.

In other embodiments, the certification authority requires that the website and politician comply with governmental guidelines for privacy. Voting records, volunteer records, and contribution records are exemplary areas that are subject to at least minimal privacy protection. The certification authority, in one embodiment, requires that the website and politician adopt a privacy policy. In one embodiment, the certification authority may audit or test the privacy policy, while in other embodiments, the certification authority may rely upon a statement by the candidate or campaign staff.

In other embodiments, the certification authority requires that the website adhere to the formalities of the election process. For example, the website is required to comply with Federal Election Commission guidelines in one embodiment, and the website is required to comply with Section 508 of the Rehabilitation Act and the Electronic and Information Technology Accessibility Standards in another embodiment. Compliance may be electronically monitored, or monitored by human intervention.

Another aspect of the invention provides a website seal that cannot be manipulated at the website to be certified. Thus, after certifying the website, the certification authority places a certificate on the political website. In other words, the certification authority controls the appearance of a seal on the certified website and is able to remove the certification, or change its appearance for all future page views. Code distributed to the certified website consults with the certification authority prior to display on a page view to ensure that the website maintains its certification level, and the image of the seal is served from the certification authority.

The invention disclosed herein may be embodied in a web interface configured to accept input data to perform the steps described herein. The method steps may be automated to use computer software to obtain information from databases connected to a network.

Furthermore, the invention may provide for real time identity assurance through software code to assure validity of the certificate. In some embodiments, the real time identity assurance comprises code to create a popup of a security certificate in response to a mouseover, wherein the popup includes the date and time as well as a digital signature or other electronic verification, of the mouseover to assure that the identity is checked in real time. In one embodiment, the popup is created using a Java script. In such embodiments, upon a website visitor performing a mouseover over the certificate, the user's computer consults with the certification authority to confirm that the certification remains valid, and if so, displays the popup. In the event that the certification is no longer valid, the certification authority will either display no certification to the user, or display a message illustrating that the certification is no longer valid. As described herein, the term mouseover is defined as any user action, including mouseovers, but including clicking or other such action.

In other embodiments, where the website has announced its intention to adhere to an ethics or other code, the certification authority may provide a popup viewing of the code in response to a mouseover or a click.

The invention disclosed herein may be practiced by Section 527 organizations, non-profits, issue oriented groups and other similar groups.

In one embodiment, the communications between computers as described herein are encrypted using any appropriate encryption algorithm.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

What is claimed is:

1) A method for certification of a political website, the method comprising:
Determining a candidate name and office;
Confirming that the determined name is registered to run for the office; and
Confirming that the URL associated with the website is controlled by the determined name.

2) The method of claim 1 further comprising placing a certification on the political website.

3) The method of claim 2 wherein the certification is subject to a scoring system.

4) The method of claim 2 wherein the website is unable to manipulate the certification.

5) The method of claim 1 further comprising:
Confirming that the website conforms to at least one of the group consisting of a code of conduct, federal laws, an unsolicited commercial email code, and a data security policy.

6) A computer readable medium storing a computer program comprising:
Computer readable code for determining a candidate name and office;
Computer readable code for confirming that the determined name is registered to run for the office; and
Computer readable code for confirming that the URL associated with the website is controlled by the determined name.

7) The medium of claim 6 further comprising
computer readable code to place a certification on the political website.

8) The medium of claim 6 further comprising:
Computer readable code to confirm that the website conforms to at least one of the group consisting of a code of conduct, federal laws, an unsolicited commercial email code, and a data security policy.
